(19) United States
(12) Patent Application Publication
(10) Pub. No.: US 2018/0327077 A1
(43) Pub. Date: Nov. 15, 2018

(54) TELESCOPING WING

(71) Applicant: Jeremiah Benjamin McCoy, Bellingham, WA (US)

(72) Inventor: Jeremiah Benjamin McCoy, Bellingham, WA (US)

(21) Appl. No.: 15/731,758

(22) PCT Filed: Jan. 28, 2015
(86) PCT No.: PCT/US2015/013275

§ 371 Date: Jul. 27, 2017

(51) Int. Cl. B64C 3/56; B64C 3/18

(52) U.S. Cl. CPC B64C 3/56; B64C 3/185

(57) ABSTRACT

A telescoping wing comprised of multiple nestling sections, capable of automatically extending and retracting, varying the span of the wing and greatly reducing the space needed for storage of the wing. The telescoping wing utilizes an internal wing spar assembly comprised of a series of adjacent sliding, interconnected wing spars within hollow individual wing sections, with wing skin panels connected by wing ribs to the wing spar assembly to provide structural support for the wing while extended, and also allow the individual sections to nestle within one another to achieve a great reduction in wingspan when retracted. Mechanical extension and retractions mechanisms work upon individual spar sections within the wing spar assembly to extend or retract the telescoping wing as needed automatically.

### BACKGROUND OF THE INVENTION

The present invention is in the technical field of aircraft structures. More particularly, the present invention is in the technical field of aircraft wings with variable geometry.

In aircraft design most aircraft use wings with a fixed wingspan, which suffer from several specific drawbacks with regard to performance and utility on the ground and in the air. While on the ground, the wingspan required for flight often takes up a great deal of space, limiting the vehicle's ability to be maneuvered and stored in a compact area. While in flight, the span has a direct relationship to wing area and aspect ratio, which determine many flight variables such as cruise efficiency and top speed. By using a retractable, variable span wing, the storage area for the vehicle when not in flight can be greatly reduced, and the flight performance characteristics can be changed at will as the mission requires, giving the operator much greater flexibility in the air and on the ground.

### SUMMARY OF THE INVENTION

The present invention is an aircraft wing comprised of multiple telescoping sections that allow the span of the wing to be greatly reduced or expanded automatically. Each section of the wing is comprised of an exterior skin panel with an airfoil cross section, connected on the inboard edge to a wing rib. The wing rib is in turn connected to a pair of wing spar sections, one forward and one aft. Structural support across the wing is provided by the interlocking design of the wing spar sections, which overlap in such a way as to maintain rigidity as a beam while allowing the length to be extended and retracted, using simple beam elements for the wing spars which nestle adjacent to one another in series.

In the design of the wing sections, the inward wing skin panels have a slightly greater cross sectional area than the outward sections, sequentially, allowing the outward sections to fit within the inward sections in series. The wing spar sections are longer than the wing skins, and connect to the wing spar sections of the adjacent wing sections with sufficient overlap to maintain structural integrity during flight. The wing ribs are constructed with a rectangular hole large enough to accommodate the entire wing spar assembly when collapsed, and each wing rib is directly fastened near the inward end to two wing spar sections for each of the sections in the wing. The wing rib on the inward edge of each wing section is also fastened directly to the wing skin of the same section, and when extended, also supports the outward edge of the next adjacent wing skin in the inward direction.

The wing spar sections together comprise the wing spar assembly which is extended and retracted to change the span of the wing. The wing spar sections are beams formed with a cross section similar to an I-beam, with flanges that are offset so that the wing spar sections can nestle against each other while the flanges overlap. The flanges are also formed with corresponding lips on each flange that serve to hook into the lips on adjacent spars and lock the adjacent sections together in the transverse axes while still allowing slip in the longitudinal axis of the beam. This design allows the spar assembly to be extended and retracted while maintaining the proper internal structural support for the wing. When fully extended, stops on the top and bottom of each spar contact the wing rib of the next outward section to prevent the beams from extending beyond the minimum overlap needed to maintain a rigid structure. Actuated or spring loaded pins at the outward ends of each wing spar extend between the flanges of the wing spars and into holes in the interlocking flanges of the adjacent wing spars when extended to further reinforce the structure.

The extension and retraction of the wing can be accomplished by one of several automatic mechanisms. In the preferred embodiment, a motor fixed to one end of each wing spar drives gears which act upon teeth set into the flange of the adjacent wing spar, extending or retracting the assembly based on the direction of rotation. Other embodiments include the use of a pulley system, in which a band or cable runs back and forth around the outside of each wing spar between pulleys at either end, drawing the spar sections outward when the cord is pulled in by a winch or other mechanism. Another embodiment would include the use of threaded rods driven by motors at the end of each spar section which would act upon a threaded nut set into a protrusion from the adjacent spar, extending or retracting the assembly based on the direction of rotation, and a final embodiment would use thin pneumatic or hydraulic cylinders connected to each end of each wing spar to push apart or draw together the spars in the wing spar assembly

The telescoping feature of the wing allows for alteration of the aspect ratio and wing area in order to change the performance characteristics of the vehicle while in flight, and for the entire wing to be contained in a minimal volume while not needed for flight. In one example, the entire wing of a small aircraft could be stored in a space no wider than an automobile which would allow a vehicle with such wings to be operated on roads with the wings stowed. In another example, a small unmanned aircraft could reduce the span of its wings in order to travel at a higher cruise speed to reach a destination, and then extend the wings to their full span in order to loiter at a slower cruise speed upon arrival with greater efficiency.

### BRIEF DESCRIPTION OF THE DRAWINGS

FIG. 1 is an external perspective view of the telescoping wing in its fully extended configuration FIG. 2 is an external perspective view of the telescoping wing in its fully retracted configuration

FIG. 3 is an internal view of the telescoping wing in its fully extended configuration with the wing skin panels removed.

FIG. 4 is an internal view of the telescoping wing in its fully retracted configuration with the wing skin panels removed.

FIG. 5 is a view of a cross-section of the wing in its retracted configuration

FIG. 6 is a perspective view of the two innermost wing sections with the wing skin panels removed, showing the preferred gear and motor extension and retraction mechanism

FIG. 7 is a perspective view of the two outermost wing sections with the wing skin panels removed, showing the preferred gear and motor extension and retraction mechanism

FIG. 8 is a front view of a wing section with the wing skin panels removed, showing the gear teeth embedded in the wing spar in the preferred gear and motor extension and retraction mechanism

FIG. 9 is a view of a wing section from the centerline of the section looking forward with the wing skin panels removed, showing the gear and motor assembly of the gear and motor extension and retraction mechanism

FIG. 10 is a perspective view of the two innermost wing sections with the wing skin panels removed, showing the alternate pneumatic extension and retraction mechanism

FIG. 11 is a perspective view of the two outermost wing sections with the wing skin panels removed, showing the alternate pneumatic extension and retraction mechanism

FIG. 12 is a front view of a wing section with the wing skin panels removed, showing the alternate pneumatic extension and retraction mechanism

FIG. 13 is a perspective view of the two innermost wing sections with the wing skin panels removed, showing the alternate pulley extension and retraction mechanism

FIG. 14 is a perspective view of the two outermost wing sections with the wing skin panels removed, showing the alternate pulley extension and retraction mechanism

FIG. 15 is a front view of a wing section with the wing skin panels removed, showing the alternate pulley extension and retraction mechanism

### DETAILED DESCRIPTION OF THE INVENTION

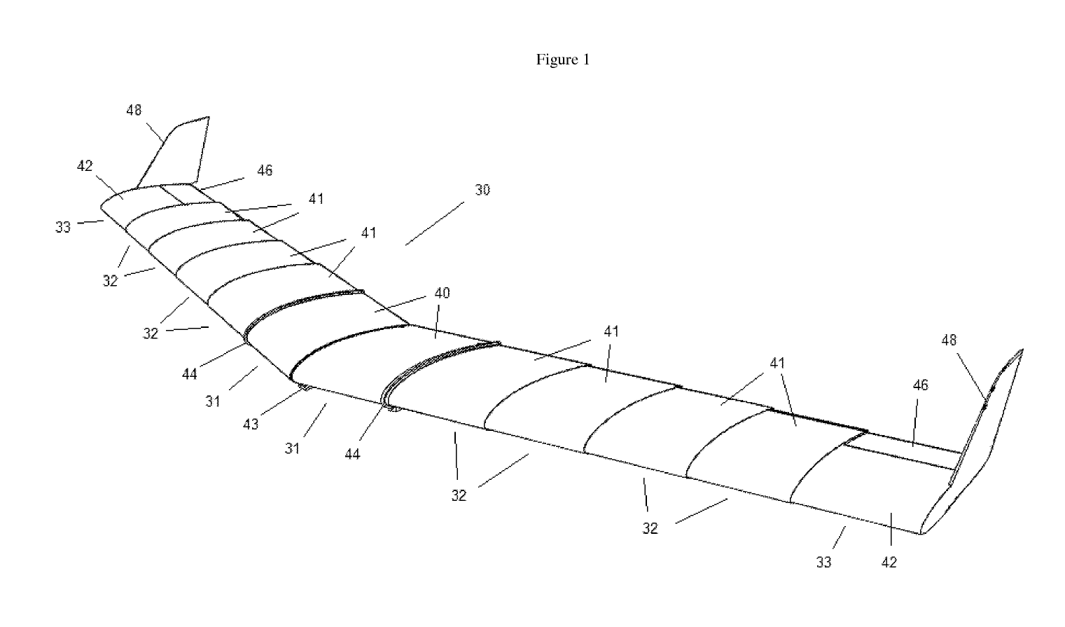

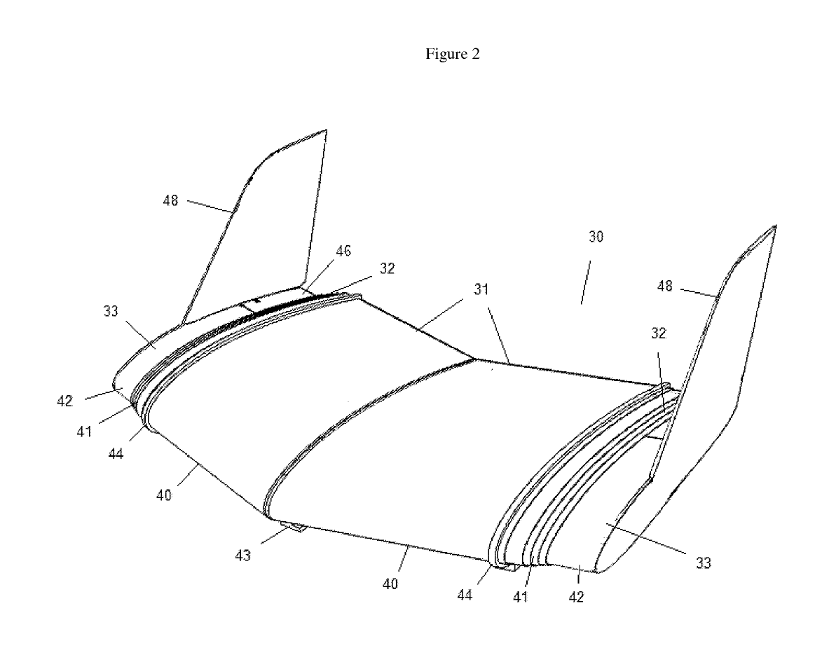

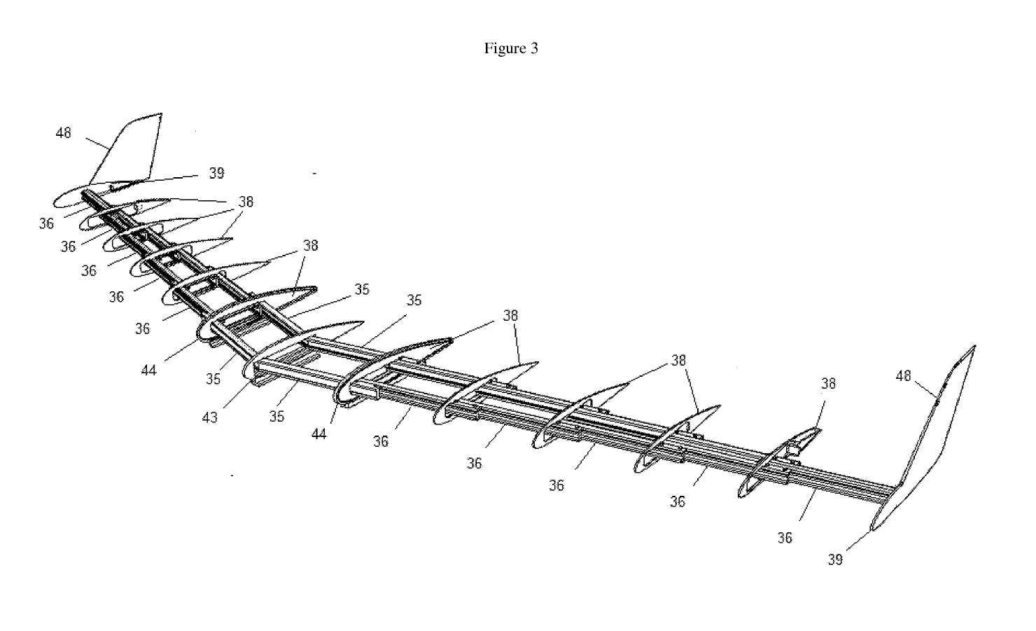

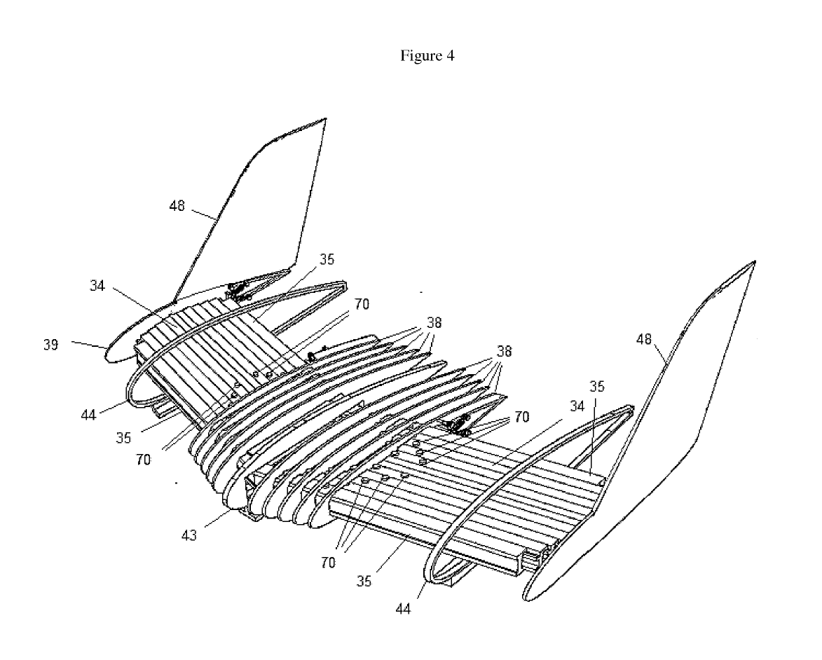

Referring now to the invention as shown in FIGS. 1 to 2, the following description relates to the construction of extendable and retractable telescoping wings. The telescoping wing 30 is comprised of a plurality of individual wing sections 31, 32, 33 which extend from the inner wing sections 31 with respect to the midline of the wings, through the intermediate wing sections 32 to the outer wing sections 33 at the tips of the wings 30. Each wing section 31, 32, 33 includes wing skin panels 40, 41, 42 that provide the external surface of the wing section 31, 32, 33. The wing panels have an airfoil shaped cross section, and provide the lifting surface of the wing. The inner wing sections 31 have wing skin panels 40 of a greater cross-sectional area than the intermediate wing skin panels 41, in order to allow the intermediate wing sections 32 and outer wing sections 33 to slide into the space within them when retracted. In the same way, intermediate wing sections 32 each have wing skin panels 41 with a greater cross-sectional area than the next intermediate wing section 32 beyond them, in the outward direction, to allow those sections to fit within them when retracted. The outer wing sections 33 at the ends of the wings 30 do not have any further sections beyond them, and thus the outer wing skin panels 42 have the smallest cross-sectional area. The inner wing sections 31 are hollow except for the central wing support 43 and central wing spars 35, and the intermediate wing sections 32 are hollow except for the wing ribs 38 and the wing spars 36, as shown in FIGS. 3 and 4, in order to allow adjacent wing sections 32, 31 to slide into the empty space contained within the wing skin panels 40, 41 when retracted. The outer wing sections 33 require only enough empty space to contain the collapsed wing spar assembly 34 when the wings 30 are retracted, and so the remainder of the space in the outer wing sections 33 can be used to accommodate ailerons 46 and actuators 71 to control them. Winglets 48 at the tips of the wings can be used to improve aerodynamic performance.

Referring to the invention as shown in FIGS. 3 and 4, the following is a description of the construction of the individual wing sections. The innermost wing sections 31, consist of three primary features: the external wing skin panels 40, shown in FIGS. 1 and 2, the central wing support 43 which supports the wing skin panels 40 and connects to the structure of the airplane, and a pair of central wing spar sections 35 that connect in the center to the central wing support 43. The innermost wing sections 31 are fixed, and the intermediate 32 and outermost 33 wing sections slide within the volume contained by the innermost wing section skin panels 40 when the wings are retracted. The intermediate wing sections 32 are also comprised of three primary features, the wing ribs 38 on the inward edge of each intermediate wing section 32, which support the wing skin panels, 41, for each intermediate wing section 32, and a pair of wing spar sections, 36 which connect to the wing ribs 38 along the inward edge of the wing section 32. The outermost wing sections 33 consist of wing skin panels, 42, supported on both ends by wing ribs 38, 39, which also connect to a pair of wing spar sections 36.

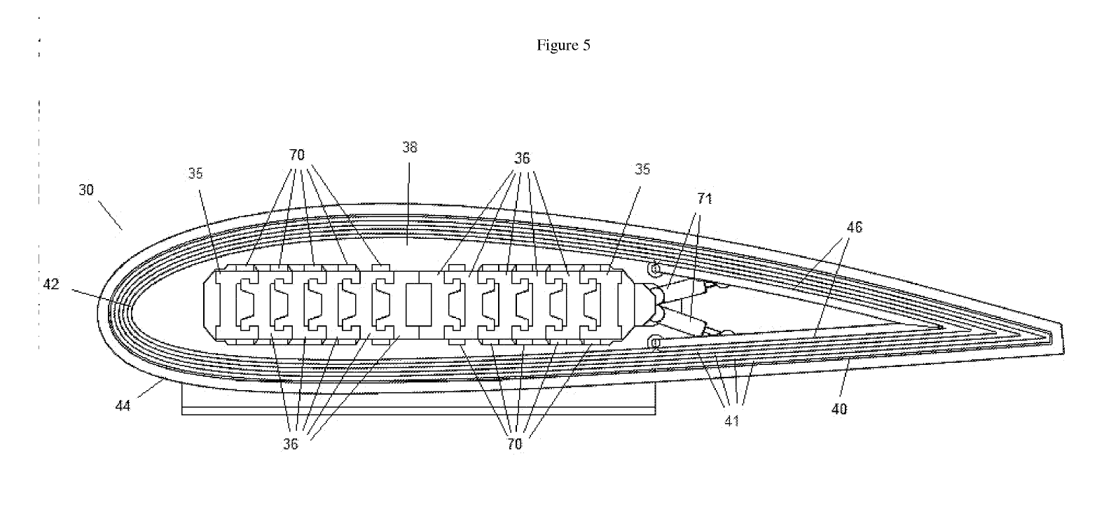

Referring to the invention as shown in FIG. 3 to FIG. 5, the following relates the construction of the internal support structure of the wings 30, the wing spar assembly 34, and how it connects to the aircraft. The central wing spars 35 and adjacent wing spar sections 36 in adjacent intermediate and outermost wing sections 32, 33, are connected by overlapping flanges as shown in FIG. 5 to form the wing spar assembly 34 which extends the length of the entire wing 30 when extended, and retracts along with the wing sections 32, 33 to the space within the innermost wing section 31 at a fraction of the fully extended length when retracted. The central wing spar sections 35 form a beam across the width of the innermost wing sections 31 and are fixed in place. The central wing spars 35 are connected to the center wing support 43 along the centerline of the wings which connects the wing spar assembly 34 to structure along the centerline of the aircraft. The wing spar assembly 34 provides internal structural support for the wing under aerodynamic loads, and connects the wing 30 through the central wing support 43 to the aircraft. In addition, the outer wing root support 44 wraps around the outside of the inner wing sections 31 and may also connect to the aircraft, carrying a portion of the vehicle weight.

Referring now to the invention as shown in FIGS. 3 to 5, the following is a further description of how the individual sections are constructed and how they connect to one another. For the inner wing sections 31, the central wing skin panels 40 are fastened on their inner edge to the central wing support 43. In the intermediate sections 32 the wing skin panels 41 of each section are fastened along the inner edge to the wing ribs 38 of each section, which have a similar airfoil shape, and provide the structural support to the wing skin panels 41. The wing ribs 38 contain an empty space large enough to accommodate the collapsed wing spar assembly 34. Each wing rib is connected to a pair of wing spar sections 36, one forward and on aft per wing section, with the distance between the wing spar sections 38 decreasing for each subsequent wing section 32 in the outward direction of the wing, in order for the wing spar sections 36 of each subsequent wing section 32, 33 to fit between the wing spar sections 36 of the section before them 31, 32 in the inward direction of the wing while maintaining the overlap between their adjacent flanges. The wing spar sections 36 fit within the empty space in the wing ribs 38 and are fastened to the wing ribs 38 along the top and bottom edges of the space within the wing ribs 38. Together, all of the wing spar sections 35, 36 in the wing spar assembly 34 fit when retracted into the space within the wing ribs 38. When the wing 30 is extended, the outboard edges of the wing skin panels 40, 41 are supported by the wing ribs 38 of the next adjacent outward sections 32, 33. The exception to this is the outermost wing sections 33, for which the skin 42 is supported on both ends by inner wing ribs 38 and outer ribs 39 connected to the outermost wing spars 36.

Referring in more detail to the invention as shown in 3 to 5, the wing sections 31, 32, 33 are supported internally by the wing spar assembly 34 which is comprised of two wing spar sections 35, 36 per wing section 31, 32, 33 utilizing an interlocking flange design that connects the adjacent wing spar sections 35, 36 into a complete wing spar assembly 34. The wing spar sections 35, 36 are designed with a cross-section in the shape of an I-beam with offset, interlocking flanges. The flanges of the wing spar sections 35, 36 are offset so that they can be situated adjacent to each other and overlap, while maintaining contact between the upper and lower surfaces of the adjacent flanges. In the area that the flanges overlap, corresponding lips on each flange connect the adjacent flanges together by creating a constraint between them in the crosswise direction while allowing adjacent spar sections to slide relative to each other in the lengthwise direction of the beam. The shape of the interlocking cross-sections allow individual wing spar sections 35, 36 to slide with respect to one another in the lengthwise direction of the wing while maintaining structural rigidity and strength in the other perpendicular directions due to the overlap between the lips and flanges of adjacent wing spar sections 35, 36.

Again referring to the invention as shown in FIGS. 3 to 5, The wing spar sections 35, 36 are longer than the wing skin panels 40, 41, 42 of each section and extend beyond the point of connection to next wing section 32 in order for the ends of the adjacent spar sections 35, 36 to overlap and maintain their structural connection while the wings 30 are fully deployed. When the extension of the wing spars 35, 36 reaches the fully extended position, stops on the top and bottom of the wing spar sections, a set distance from the ends of the spars equal to the desired overlap between adjacent spars while extended, contact the wing rib of the next outward section and restrain any further sliding outward. Pneumatically or electrically actuated pins 70 fitted on the upper and lower flanges of the wing spars then extend into corresponding holes in the flanges of the adjacent wing spar sections 36, connecting the overlapping upper and lower flanges of the adjacent wing spar sections 35, 36, fixing them in relative position to each other and carrying a portion of the stress across the top and bottom of the wing spar assembly 34. In the invention as shown in the figures, the stop that retains the outward sections of the wing is also the housing for the inward wing spar pin 70 on that section of the wing spar. Also, the spaces in the wing ribs 38 which accommodate the wing spar assembly 34 are shaped to allow the actuated pin mechanisms 70 and stops of the non-adjacent outward wing spar sections 36 to pass without contact, in order for the whole wing spar assembly 34 to be able to slide freely into its fully retracted or extended state.

The construction details of the invention as shown in FIGS. 1 to 5 include choosing materials for the wing spar sections 35, 36, the wing ribs 38 and the wing skins 40, 41, 42 that have a high strength and low weight, such as extruded carbon fiber rod or other high strength composite material, although metallic materials may be considered as well. The skin panels are to be constructed of lightweight panel material such as carbon fiber, fiberglass, or other composite panels formed on molds. Materials and dimensions of all components shall be determined to meet the requirements of reliability and strength for the aircraft which will utilize the wing.

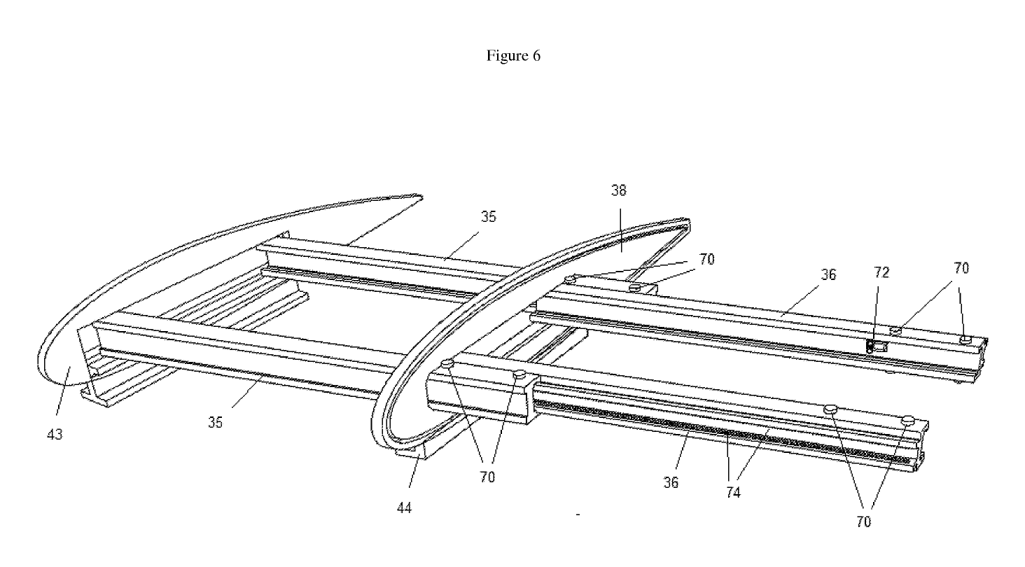

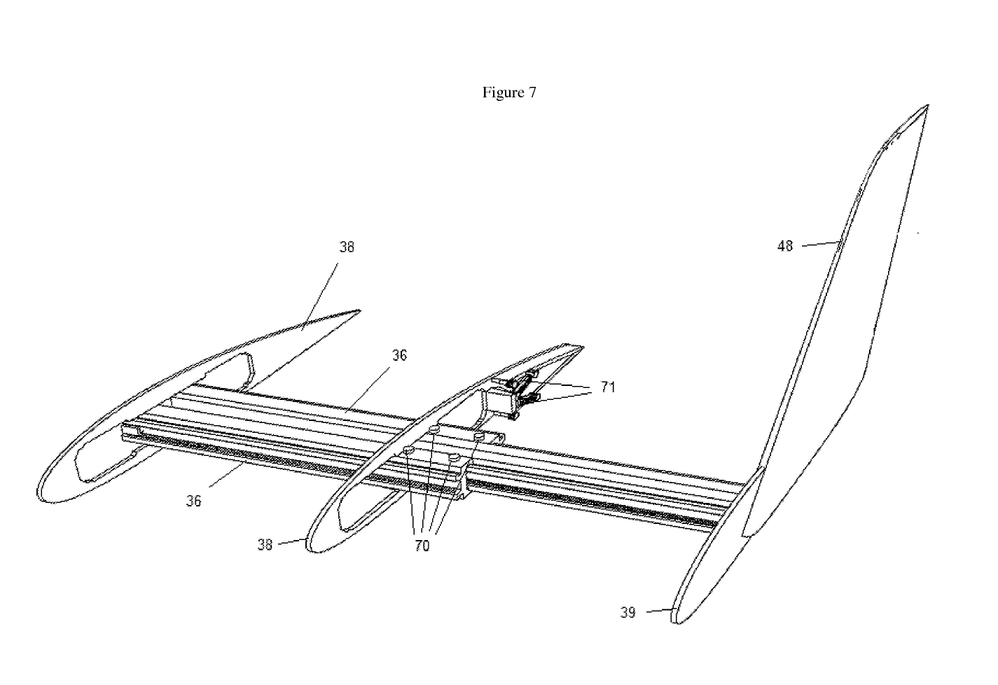

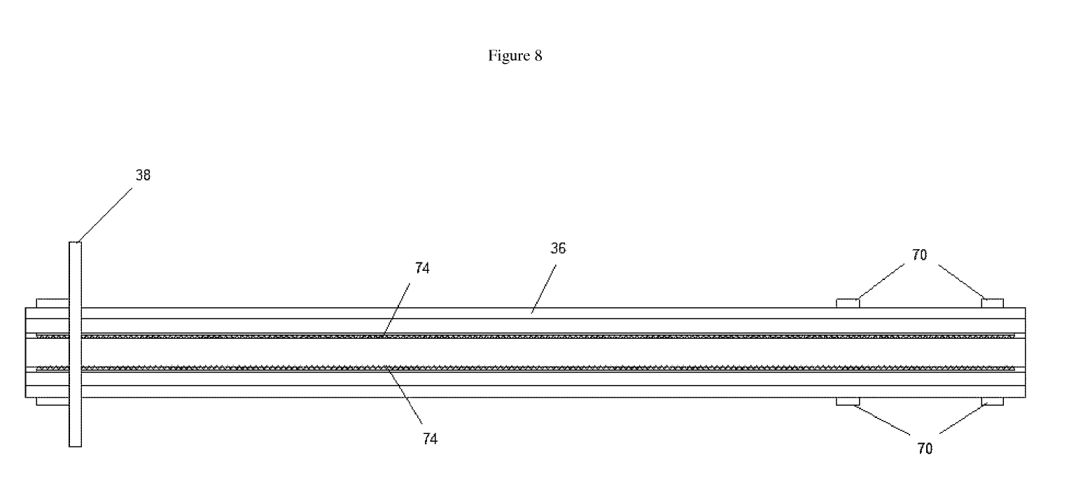

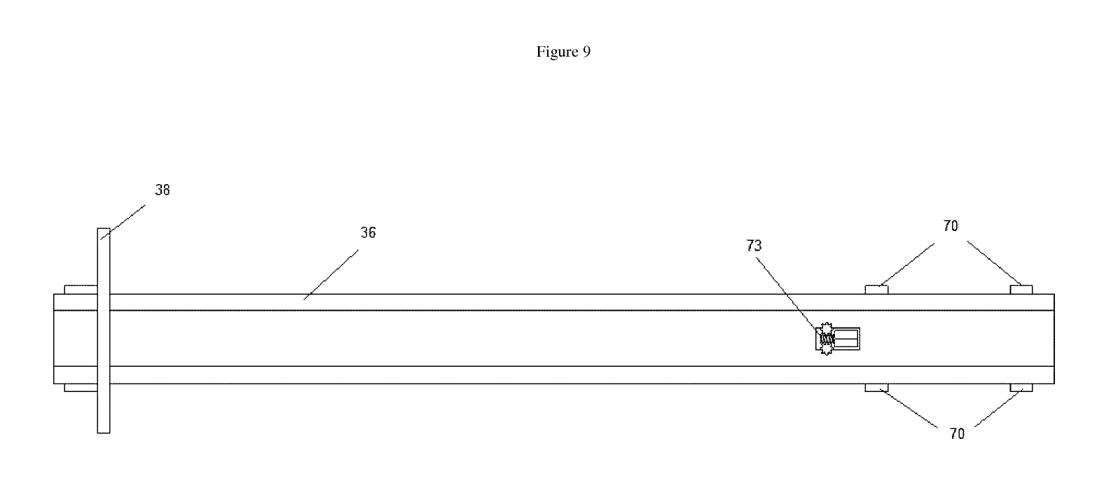

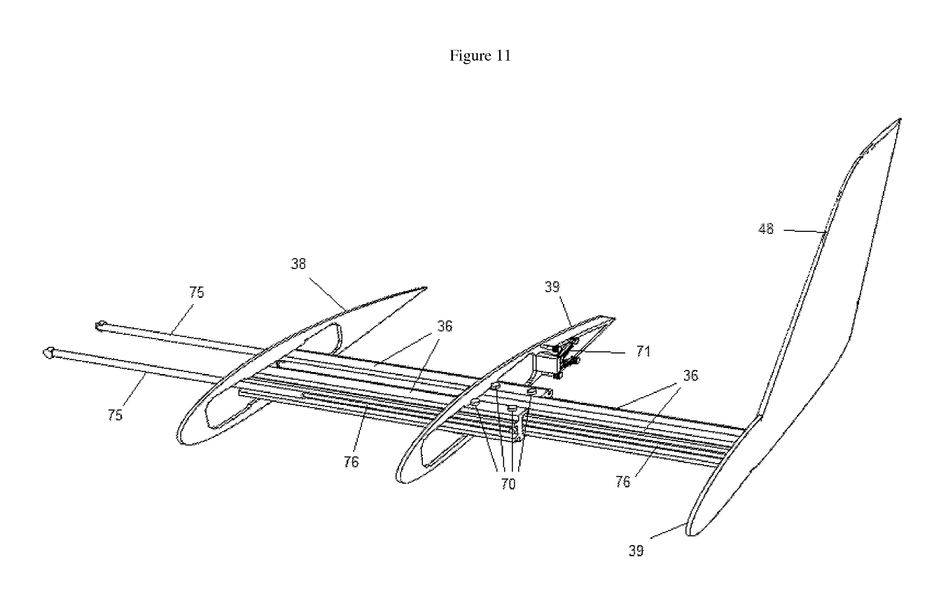

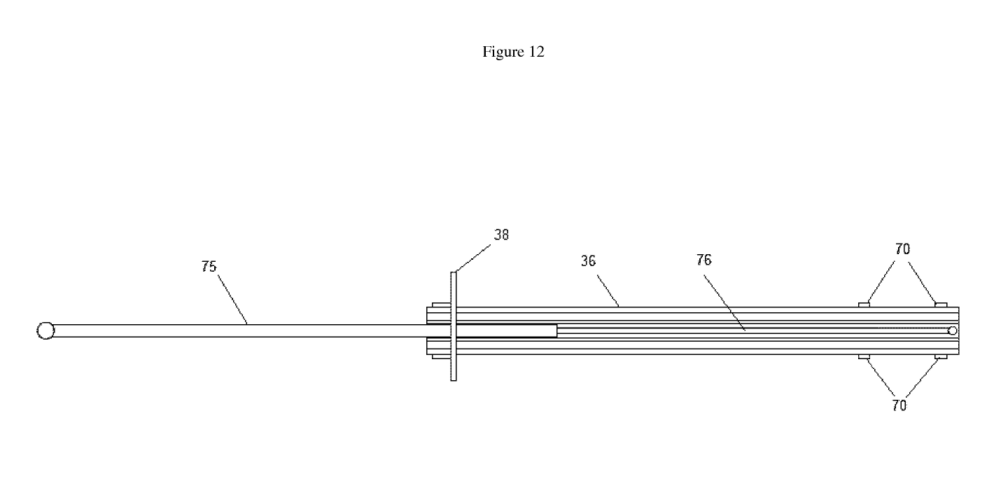

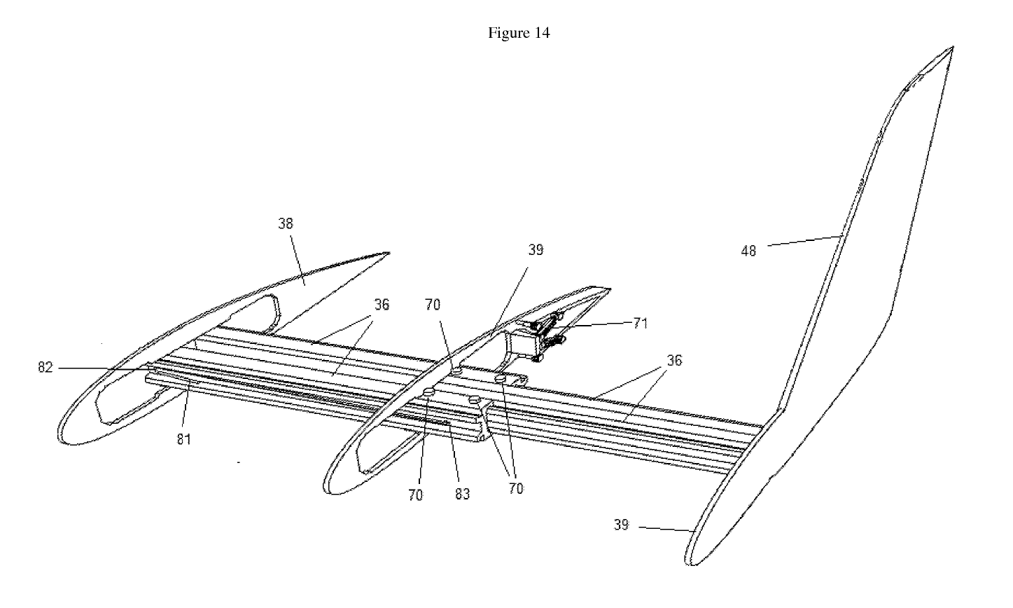

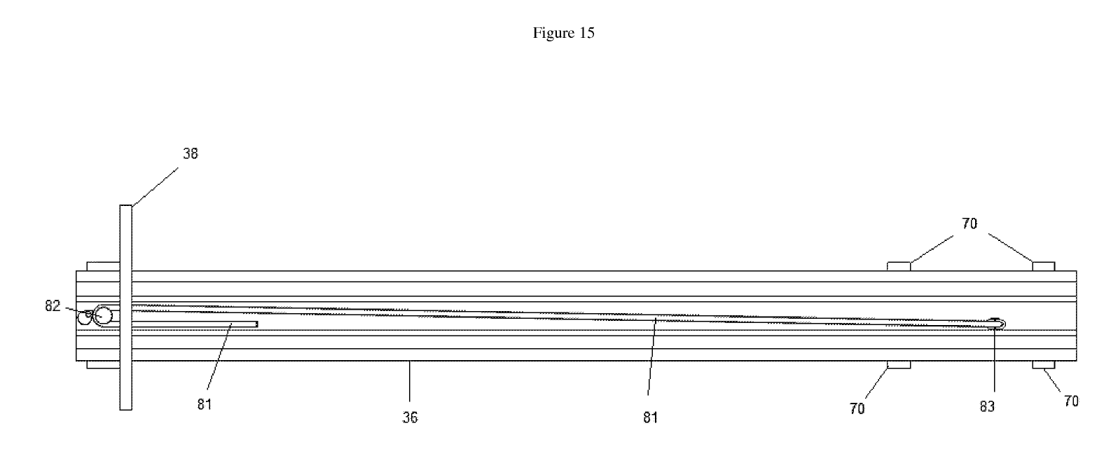

Referring now to the invention as shown in FIGS. 6 to 15, extension and retraction mechanisms are included on each wing spar section 32 in order to extend and retract each set of spars in the wing spar assembly 34, and along with them the wing ribs 38 attached to the wing spar sections 32, 33, and the outer wing skin panels 41, 42 attached to the wing ribs 38, thereby fully extending or retracting the whole wing 30. There are several different possible embodiments of the mechanisms to automatically extend and retract the wing sections, described below.

Referring now to the invention shown in FIG. 6 to FIG. 9, in the preferred embodiment of the extension and retraction mechanism, the wings are retracted and extended by geared motor assemblies 73 that are mounted to the interior end of the wing spar sections 36 and being mounted to the edge of one wing spar section 36 while the teeth of the gears in the gear motor assembly 73 act upon teeth 74 set into the spar flange of the adjacent wing spar section 34, 35. This mechanism allows the gear motor 73 to drive one wing spar section 34 inward or outward with respect to the adjacent wing spar section 34, 35 in the lengthwise direction of the wings 30, depending on the direction of rotation of the gears.

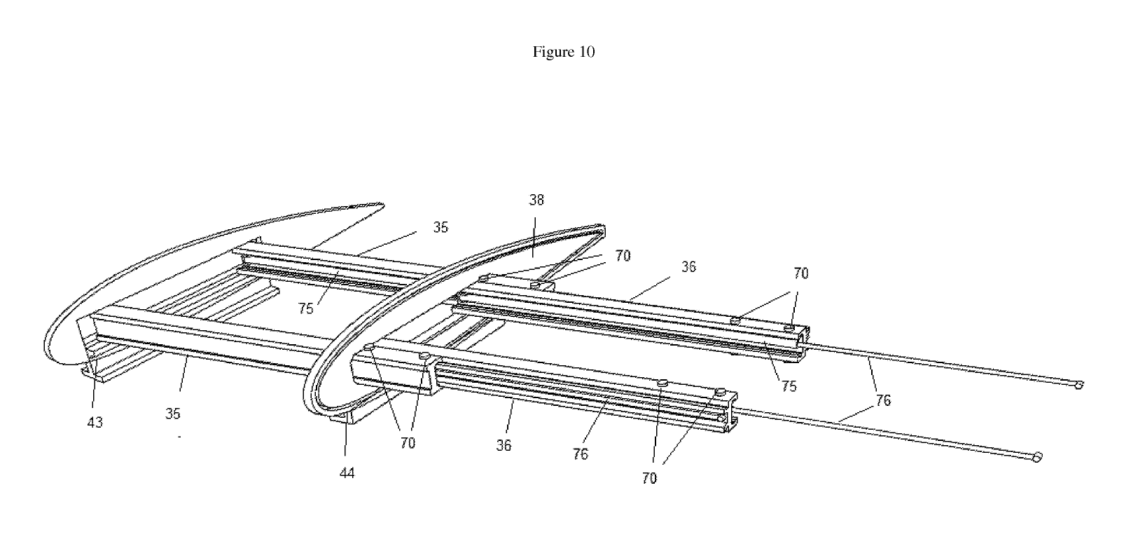

Referring now to the invention shown in FIGS. 10 to 12, in an alternative embodiment of the extension and retraction mechanism, the wings are retracted and extended by hydraulic or pneumatic cylinders 75 that are mounted between the inward end of each wing spar section and the outward end of each adjacent wing spar section. The hydraulic or pneumatic cylinders are comprised of an outer cylinder 75 and an inner piston 76 that extends or retracts under the application of positive or negative pressure. The base of the outer cylinder 75 is fixed to one end of each wing spar section 34, 35, while the end of each piston 76 has an attachment connecting it to the adjacent wing spar section 34 upon which the cylinder 75 acts, extending or retracting the wing sections.

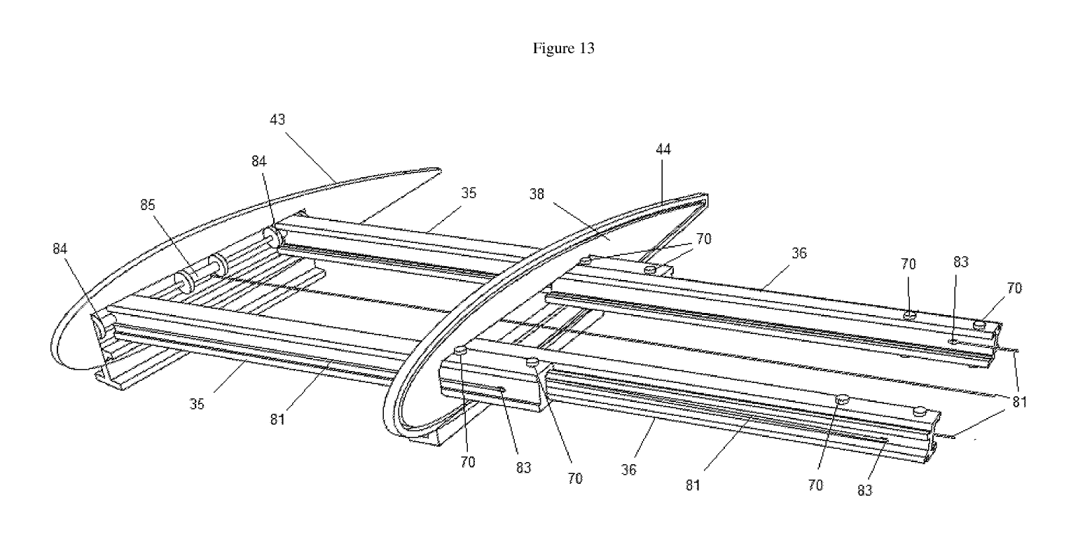

Referring now to the invention shown in FIGS. 13 to 15, in an alternative embodiment of the extension and retraction mechanism, the wings are retracted and extended by a cable 81 which runs between pulleys 83 in the outward end of each wing spar section 34 mounted horizontally in a slot within the wing spar 34 and another pulley 82 mounted vertically at the inward end. The cord is pulled by a winch 84 at the far inward end of the wing 30, pulling the inward and outward ends of adjacent wing spars 34, 35 closer to each other, thus extending the wing sections 32, 33. Retraction is accomplished by pulling the cord 81 attached to the most outward wing section 33 inward by a retraction winch 85.

The advantages of the present invention include, without limitation, the capability to provide lift for an aircraft in the same manner as a traditional aircraft wing, while also allowing the span and volume of the wing to be greatly reduced to a fraction of its full length while the vehicle is not in flight. This capability reduces the storage space required for the vehicle and also allows the wings to be contained in a space narrow enough to be incorporated into a vehicle that can be driven on roads as well as flown. A further advantage of the present invention is the optional capability to vary the aspect ratio and wing area of the wing while in flight. This capability has many applications in aircraft design, as it allows the operator to change the flight characteristics at will. This can be used to adjust the maximum efficiency and cruise speed of the aircraft for different flight scenarios, dramatically expanding the capabilities of a single aircraft. A high aspect ratio design is more efficient for a low speed loiter, while a low aspect ratio design allows for higher top speed, thus being able to alter the aspect ratio in flight is a very useful capability for a multi-use aircraft such as a UAV.

In broad embodiment, the present invention is a wing comprised of a plurality of nestling sections, capable of extending and retracting telescopically while maintaining a rigid internal support structure. The wing is capable of providing lift for an aircraft with the strength and reliability needed for the aircraft lifetime, and when not in use, being stored within a compact volume. Optionally the wing can be designed to have a variable span that can be changed in flight, in order to alter in-flight performance characteristics of the vehicle.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1: A Telescoping wing, being deployable to an extended or retracted state, comprising a plurality of individual sections, each section comprising two wing spar sections, a wing rib affixed to the inward edges of said wing spar sections, and a wing skin affixed to said wing rib, wherein each section is constructed such that:
wing spar sections of each adjacent wing section include a means of connecting adjacent sections while allowing transverse relative motion in the span-wise direction between adjacent wing spars,
wing spar sections of each section being longer in the span-wise dimension than the wing skins,
wing ribs of each section affixed on the inward edge of said wing section, being constructed to allow an empty space large enough in dimension to allow wing spar sections of all wing sections to slide within said empty space,
and wing skins being constructed such that inward sections along the span of the wing are of a greater overall interior dimension than the outer dimension of the wing skins of adjacent outer sections, allowing said wing skins to nestle within one another.

2: A telescoping wing of claim 1, wherein wing spar sections comprise an extruded length, of a cross sectional shape similar to an I beam, with offset flanges allowing adjacent beam sections to nestle against one another and corresponding lips on the upper and lower surfaces of said flanges, as a means of adjoining adjacent sections while allowing relative motion in the span-wise direction between adjacent wing spars for the extension and retraction of the wings.

3: A telescoping wing of claim 1, wherein a telescoping wing is connected to support structures such that the inward-most wing spar and inside edge of the innermost wing section is affixed to a central wing support, and the outer edge of the innermost wing section is affixed to an outer wing support, said supports including means of being mechanically attached to a frame or vehicle.

4: A telescoping wing of claim 1, wherein actuated pins affixed toward the outward ends of wing spar sections upon overlapping flanges extend when the telescoping wings are in fully extended position into corresponding holes within the flanges of adjacent wing spar sections, locking the wing spar sections in a rigid formation restrained from motion in the span-wise direction of the wings.

5: A telescoping wing of claim 1, wherein said wings contain means to be extended and retracted automatically, by mechanical means.

6: A telescoping wing of claim 5, wherein said means of automatically extending and retracting said wings comprise a gear and motor assembly attached to each wing spar section which acts upon linear teeth embedded in adjacent wing spar sections

7: A telescoping wing of claim 5, wherein said means of automatically extending and retracting said wings comprise pneumatic or hydraulic pistons connected to the inner and outer ends of adjacent wing spars.

8: A telescoping wing of claim 5, wherein said means of automatically extending and retracting said wings comprise a cable running around a plurality of pulleys, one at each end of each wing spar section such that pulling on the cables brings the pulley on the outer end of one wing spar section closer to the pulley on the inner end of the next outward wing spar, extending the telescoping wings, and a secondary cable connected directly to the outer most wing spar sections, such that pulling said cable retracts the telescoping wings.
